(19) United States
(12) Patent Application Publication
(10) Pub. No.: US 2012/0143394 A1
(43) Pub. Date: Jun. 7, 2012

(54) VEHICLE SENSOR, SYSTEM HAVING A CONTROLLER FOR VEHICLE STATE DETERMINATION AND AT LEAST TWO VEHICLE SENSORS, AND METHOD FOR OPERATION OF A SYSTEM HAVING A CONTROLLER FOR VEHICLE STATE DETERMINATION AND AT LEAST TWO VEHICLE SENSORS

(75) Inventors: Bernd Tollkuehn, Novi, MI (US); Peter Guse, Stuttgart (DE)

(73) Assignee: Robert Bosch GmbH, Stuttgart (DE)

(21) Appl. No.: 13/322,053

(22) PCT Filed: Apr. 16, 2010
(86) PCT No.: PCT/EP10/55025

§ 371 Date: Feb. 13, 2012

(30) Foreign Application Priority Data
May 25, 2009 (DE) 10 2009 026 430.2

(51) Int. Cl. G06F 17/00

(52) U.S. Cl. 701/1

(57) ABSTRACT

A vehicle sensor as well as a system having a controller for vehicle state determination and at least two vehicle sensors, as well as a method for operation of a system such as this, are proposed. At least one first vehicle sensor is connected only by radio to the controller and/or to at least one second vehicle sensor for a first data transmission. The at least one second vehicle sensor is connected by cable to the controller for a second data transmission.

### PRIOR ART

The invention relates to a vehicle sensor and to a system having a controller for vehicle state determination and at least two vehicle sensors as well as a method for operation of such a system according to the generic type of the independent patent claims.

DE 11 2006 003 053 T5 discloses a wireless rotational speed sensor in which the rotational speed of a motor vehicle wheel or motor vehicle tire is measured and the measured values which are recorded by the sensor are conditioned to form a data telegram which indicates the rotational speed of the wheel. Furthermore, the sensor is configured in such a way that the data telegram is transmitted in a wireless fashion. In order to measure the wheel speed, a measuring unit measures changes in the magnetic flux and transmits back in a wireless fashion a corresponding signal to a base station or to a control unit. The present sensor component comprises a battery or some other type of energy or energy source which generally supplies relatively little energy, such as for example from a supply with low voltage. Furthermore, what is referred to as an ECU component can instruct the sensor component to go into a sleep mode in order to save battery current since the vehicle may be in a stopped state. US 2004/0150516 A1 discloses a wireless rotational speed sensor system in which necessary energy is generated and/or stored in order to supply the wireless rotational speed sensor. In this context, an energy management system is provided which uses a generator for generating energy, which generator utilizes the rotation of the vehicle wheel for the generation of energy. A high-efficiency rechargeable battery or a supercapacitor is used as the storage device. What is referred to as a multipolar rotational generator can be used as the generator. The sensor element can go into a sleep mode or can be switched to an inactive state until the controller awakens the sensor by means of its sensor module.

### DISCLOSURE OF THE INVENTION

The vehicle sensor according to the invention or the system according to the invention having a controller for vehicle state determination and at least two vehicle sensors and the method according to the invention for operating such a system having the features of the independent patent claims have, in contrast, the advantage that at least one of the vehicle sensors has an interface for a cable-bound data transmission to the controller. This cable-bound data transmission from the at least one vehicle sensor to the controller permits data to be continuously transferred to the controller or exchanged with the controller, wherein the controller can then always keep the vehicle state determination in an up-to-date state. This network topology composed of the vehicle sensors and the controller permits a high degree of flexibility for the data transmission, which optimizes the data transmission speed, the energy consumption of the vehicle sensors and strategies with respect to failures of individual vehicle sensors. The cable-bound data transmission permits a very high data transmission rate. It is therefore possible with the network topology according to the invention that the at least one vehicle sensor which operates the cable-bound transmission with the controller can be embodied as a network node. In particular, this network topology combines the advantages of the wireless transmission of vehicle sensors to the controller with the cable-bound transmission, because if only a minority of the vehicle sensors, generally one, is connected to the controller cable, cable connections over a large area are dispensed with, giving rise to considerable savings in terms of raw materials, weight and costs. In particular, this simplifies the assembly of the vehicle sensors since just one vehicle sensor or a few vehicle sensors requires/require a cable connection. As a result, relatively high degrees of freedom occur in the assembly of the vehicle sensors. As is stated further below, the vehicle sensors which operate the data transmission in a radio-based fashion can carry out this data transmission at a low data rate or in an event-oriented or rule-based fashion. That is to say these vehicle sensors transmit data only when the measured values indicate that it is necessary. In this context, it is possible, for example, to initiate the transmission through the exceeding of a threshold value of a measured value.

For example, in an emergency operating mode when the radio transmission fails, the vehicle state can be determined solely by the cable-bound sensor or sensors.

In the present case, a vehicle sensor is such a sensor which measures a vehicle variable and converts it into an electrical signal. These vehicle sensors are mounted remotely from the controller in the vehicle. However, it is possible for the transmission also to take place from a vehicle sensor within the controller. Examples of such vehicle sensors are rotational speed sensors as a component of an anti-lock brake system, of an anti-slip brake controller or of an electronic stability program, of an electro-hydraulic brake as well as for engine control and/or transmission control. Other examples are radar sensors in what is referred to as an adaptive cruise control system or ultrasonic sensors and radar sensors or video sensors in a parking assistant or sensors which are used for fatigue detection such as video sensors. Further examples are sensors for what is referred to as active front steering, that is to say for steering sensors and four wheel steering for adaptive illumination or for an electro-hydraulic steering system, which is referred to as electro-hydraulic energy steering.

The radio interface is in the present case at least one receiver system which can receive radio signals and feed them to further processing in the vehicle sensor. However, a transmitter module can furthermore also be provided in order also to transmit radio signals, for example in order to permit bidirectional communication with a communication party such as a further sensor or the controller. For the radio transmission it is possible, for example, for sequence spreading, such as DSSS (direct sequence spectrum) or continuous changing of the transmission frequency (FHSS: frequency hopping spectrum) to be used. What is referred to as RFID, that is to say what is referred to as transponder technology can also be used in the present case. In this context, the energy supply can also be provided by means of emitted electro-magnetic waves, wherein the induced current is rectified in an antenna coil in the sensor module and charges an energy store such as a capacitor. The energy store supplies the chip for the current for the reading process or can be used to supply only the microchip. The emission of signals occurs directly from the transmitter in a controller or from an external transmitter to the sensor. The RFID tag modulates the electromagnetic shaft and in this way transmits the information.

All possible modulation techniques such as time-division multiplexing or frequency-division multiplexing and frequencies can be used for the radio transmission.

The radio-based data transmission is accordingly the transmission of data by radio such as has been described above.

The vehicle sensor according to the invention also has an interface for cable-bound data transmission. This interface uses a cable, which can be embodied in an electrical or optical fashion, to connect the vehicle sensor to the controller for transmitting data. An example of such a cable-bound data transmission is what is referred to as the PSI-5 interface such as is described on www.psi5.org. However, other cable-bound transmissions are also possible depending on the necessary data transmission rate, the installation conditions and costs. On this cable-bound data transmission can be embodied unidirectionally or bidirectionally.

The system here denotes a network topology composed of the controller for vehicle state determination and at least two vehicle sensors, wherein the controller for vehicle state determination is a structural unit, usually with a housing, which is, for example, a vehicle movement dynamics control system, a brake control system and/or an airbag controller. However, other vehicle states can also be alternatively or additionally determined by this controller.

It is characteristic of the system according to the invention that at least one vehicle sensor is connected to the controller or to the other vehicle sensors only by radio. At least one other vehicle sensor is then connected to the controller via cable for the data transmission. However, this further vehicle sensor also has a radio interface. A cable connection between the sensors is also conceivable.

The data which are transmitted here are, for example, data telegrams in which the actual sensor values are contained. The sensor signal represents the sensor values which the sensor element outputs. This may also be a multiplex of sensor signals. Apart from the useful data, for example in sensor values, this data telegram can also have further data such as identification data or additional data for fault correction.

The method according to the invention describes how the system according to the invention is operated. The flexible approaches described above are therefore then possible for a corresponding network topology.

Advantageous improvements of the subject matters described in the dependent claims are possible by virtue of the measures and developments described in the dependent claims.

It is advantageous that the radio interface of the vehicle sensor is configured only for receiving the data. This permits a very simple embodiment of the vehicle sensor, with the result that this vehicle sensor, which also has the cable-bound connection to the controller, thus merely collects the data of the other vehicle sensors per radio and then transmits said data in a multiplex, or after pre-processing or after prioritization, to the controller at a higher transmission rate via the cable.

This vehicle sensor according to the invention can advantageously have a control which, when the cable-bound or the radio-based data transmission fails, switches over to the respective other type of transmission. The vehicle sensor according to the invention is used here as a network node. It is then particularly advantageous here that when one type of transmission, that is to say the radio-based or the cable-bound data transmission, fails, the respective other type of transmission is used. There is therefore redundancy present, which is also utilized according to the invention. This increases the reliability of the data transmission. The control is implemented, for example, by means of software or else hardware in the electronics of the vehicle sensor and said control evaluates, for example by measurements or exchange of data with communication parties, the presence of the respective transmission path, that is to say the radio-based transmission or the cable-bound data transmission.

It is advantageous that the cable-bound data transmission has, as already indicated above, a higher transmission rate than the radio-based data transmission. The data of the vehicle sensors can therefore then be transmitted in a concentrated fashion by means of the cable-bound data transmission, while the individual sensors transmit their data to the network nodes, that is to say the vehicle sensor, with radio-bound and cable-bound data transmission at a relatively low data transmission rate. As a result, the controller can receive and also evaluate the data at a relatively high transmission rate. In particular, the vehicle sensors which have only the radio-based data transmission require little energy by virtue of their relatively low data transmission rate, in particular if they have a measuring principle which acts on a generator basis. Even when there is a battery supply or some other energy store, it is advantageous to have a relatively low data transmission rate for the radio transmission in order to save energy. In contrast, the vehicle sensors with the cable-bound data transmission can, for example, be additionally supplied with energy via the cable itself.

The advantageous use of the vehicle sensor with radio-based and cable-bound data transmission as a communication node permits a high degree of freedom in the arrangement, mounting and configuration of the vehicle sensors in the vehicle. The data transmission of the individual vehicle sensors then does not always have to be carried out as far as the controller but rather can also be oriented to a closer vehicle sensor which acts as a communication node. As a result, relatively simple and economical components can be used. However, it is also additionally possible to embody a vehicle sensor which has only radio-based data transmissions as a communication node in order, for example, to serve other vehicle sensors as a receiver station. As a result, not every vehicle sensor requires a large amount of energy but rather just this communication node, which then transmits the data directly to another communication node or to the controller. This formation of a hierarchy in the vehicle sensors also leads to simplification and a relatively high degree of flexibility of the network topology.

As already indicated above, a unidirectional embodiment of the data transmission is particularly simple, but also then has the advantage for the configuration of the transmitter and receiver modules in bidirectional embodiments that an exchange of data is possible, which, in particular, facilitates the detection of a failure of a communication path.

Exemplary embodiments of the invention are illustrated in the drawing and will be explained in more detail in the following description. In the drawing:

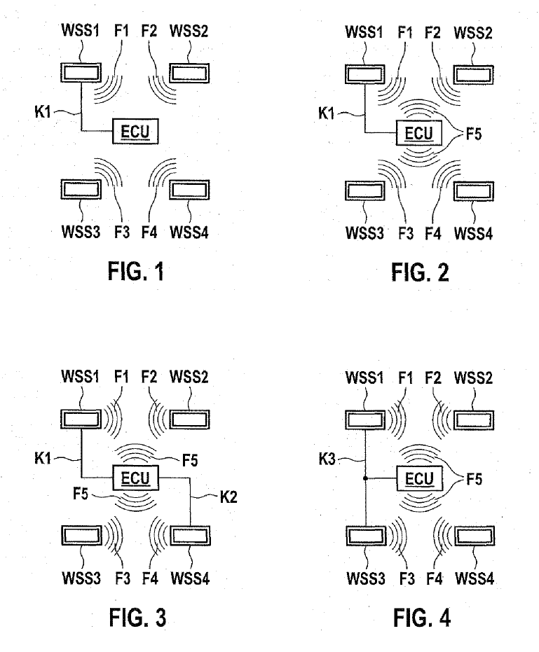

FIG. 1 shows a first network topology,

FIG. 2 shows a second network topology,

FIG. 3 shows a third network topology, and

FIG. 4 shows a fourth network topology,

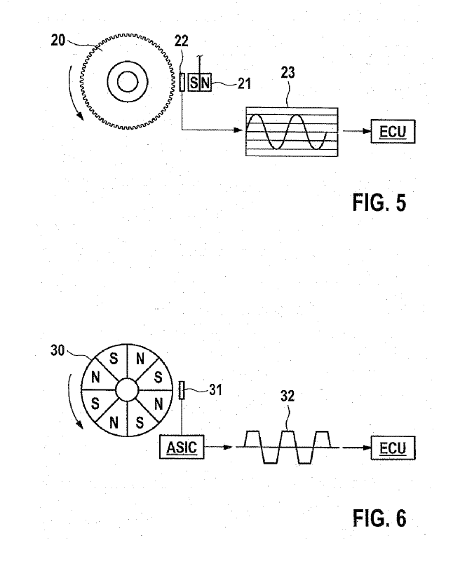

FIG. 5 shows a first embodiment of a rotational speed sensor,

FIG. 6 shows a second embodiment of a rotational speed sensor,

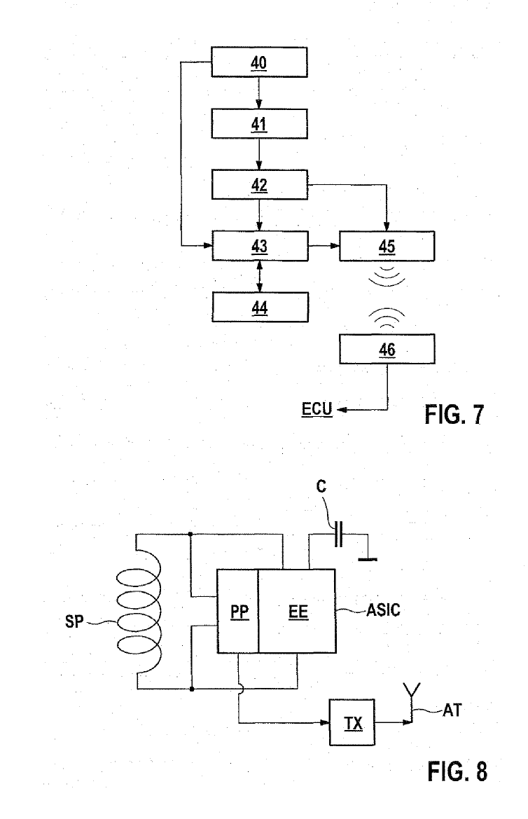

FIG. 7 shows a block circuit diagram of the vehicle sensor according to the invention and of a controller,

FIG. 8 shows a circuit component of the vehicle sensor for the generation of energy and of sensor signals,

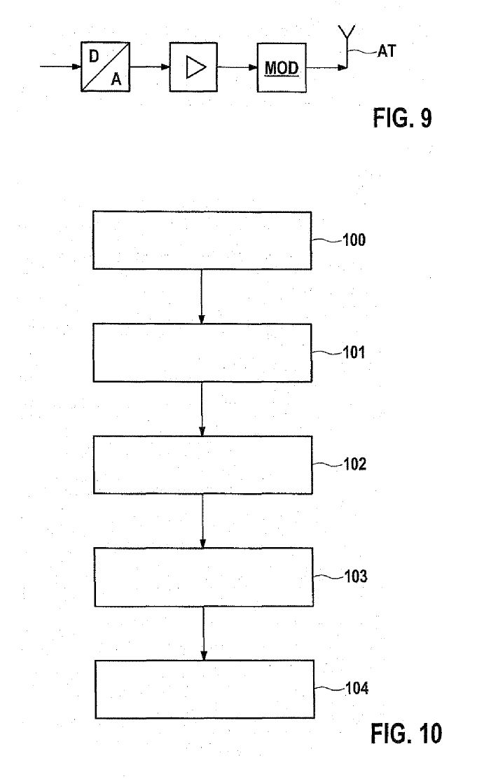

FIG. 9 shows a block circuit diagram of a transmitter,

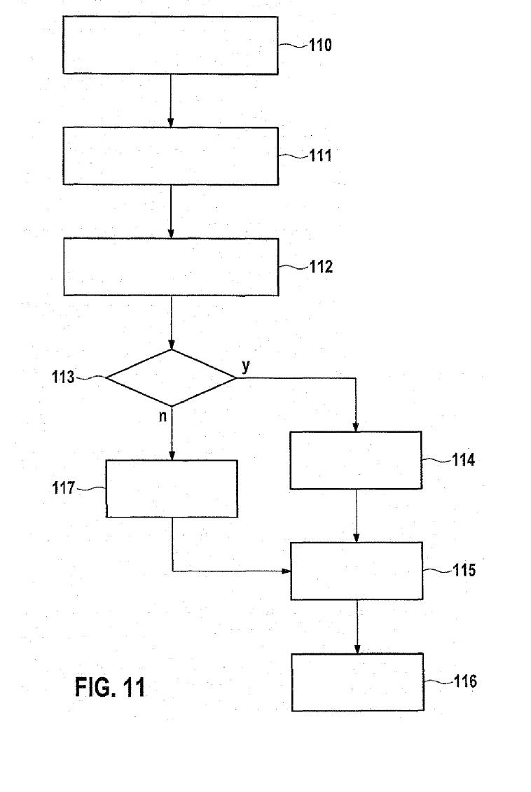

FIG. 10 shows a flowchart of the method according to the invention,

FIG. 11 shows a further flowchart of the method according to the invention,

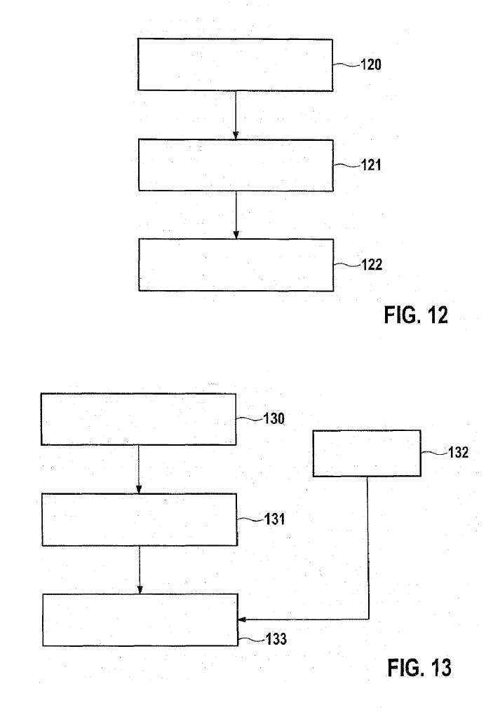

FIG. 12 shows a further flowchart of the method according to the invention, and

FIG. 13 shows a further flowchart of the method according to the invention.

FIG. 1 shows a first network topology of the system according to the invention in a block circuit diagram. A controller ECU is connected to a first vehicle sensor WSS1 via a cable K1. This first vehicle sensor, for example a rotational speed sensor like the others, also has in addition to the cable interface a radio interface for radio transmission F1. The other vehicle sensors WSS2 to 4 have only the radio-based data transmission F2 to 4. The controller ECU itself does not have a radio interface. In this case, the first vehicle sensor WSS1 receives the data of the other vehicle sensors WSS2 to 4 from said sensors and transmits said data via the cable K1 to the controller ECU, with the result that the controller ECU is enabled to determine the vehicle state. The radio transmission can be embodied in a unidirectional fashion here since there is no redundancy of the data transmission paths. This simplifies the embodiment of the communication interfaces. The cable-bound data transmission from the first vehicle sensor WSS1 to the controller ECU can also be embodied in a unidirectional fashion, for example as what is referred to as the PSI5 interface. The individual vehicle sensors, which only have the radio transmission, can, for example, have a measuring principle which acts on a generator basis, and can therefore generate the energy necessary for their operation by means of the measurement itself. Alternatively it is possible for the individual sensors WSS2 to 4 to have a battery or to acquire the necessary energy, for example from the sensor WSS1, by radio. The sensor WSS1 can receive the energy from the controller ECU via the cable K1, for example. However, if the cable K1 is, for example, of optical design, the sensor WSS1 can then also have a measurement principle which acts on a generator basis or a different energy source. The controller ECU and/or the sensors can be connected to further controllers, network nodes and/or sensors (not illustrated) by radio and/or via cables for data transmission.

The second embodiment of a network topology according to the invention is illustrated in FIG. 2. In contrast to FIG. 1, the controller ECU now also has a radio transmission F5. Otherwise, identical reference symbols denote identical elements to those in FIG. 1. Through the addition of a radio interface for the controller ECU it is possible that, on the one hand, redundancy of the transmission paths between the first vehicle sensor WSS1 and the controller ECU is present and therefore switching over is possible if one of these data transmission paths fails. On the other hand, the controller ECU can communicate directly with the vehicle sensors which have just one radio interface. It is possible, for example, for some of the vehicle sensors, for example WSS3 and WSS4, to be closer to the controller ECU than to the vehicle sensor WSS1. In order to keep the energy for the data transmission at a minimum, it is then advantageous here that such sensors which are closer to the controller ECU than to the first vehicle sensor WSS1 transmit their data directly to the controller ECU. This can be done, for example, via correspondingly addressing the radio signals to the controller ECU by correspondingly encoding the data which can only be decoded by the controller ECU or by carrying out a type of arbitrage, such as is customary in a bus principle. Direct identification of the radio signals is also possible in that, for example, a header contains an address from which the controller ECU recognizes that this data is intended for it, and from which the first vehicle sensor WSS1 recognizes that this data is not intended for it. The radio signals can also be dimensioned in terms of their energy or amplitude such that the damping prevents the radio signals from reaching receivers other than the desired one.

FIG. 3 shows a further variant of the network topology according to the invention. Again, identical reference symbols denote identical elements. In contrast to FIG. 2, there is the addition of the cable K2 between the controller ECU and the sensor WSS4. As a result, two communication nodes can now be provided by means of the vehicle sensor WSS1 and the vehicle sensor WSS4. As a result, for example, the vehicle sensor WSS3 can transmit its data to the sensor WSS4, and the sensor WSS2 can transmit its data to the vehicle sensor WSS1, and the vehicle sensors WSS1 and WSS4 then transmit this data and their own measurement data to the controller ECU. The corresponding redundancy is provided through the radio transmission possibility of the controller ECU.

FIG. 4 shows a fourth network topology which differs from FIG. 2 in that a cable K3 is provided to which the vehicle sensor WSS1, the vehicle sensor WSS3 and the controller ECU are connected, with the result that a bus connection is formed. This is an alternative to FIG. 3 with two network nodes WSS1 and WSS3, which are then connected to the controller ECU via a bus connection K3.

FIG. 5 shows the method of functioning of an active rotational speed sensor which, for operation, is connected to a voltage source with to the energy source. The vehicle sensors detect the change in the magnetic flux density. For example, a Hall sensor is provided here as the sensor element 22, said Hall sensor measuring the change in the magnetic flux density of the steel wheel 20. In addition, a magnet 21 is provided, which is changed by the rotating steel wheel in its magnetic field. The resulting signal is a sinusoidal signal 23 which is passed on to the controller ECU for further processing.

A further embodiment of rotational speed sensors is illustrated in FIG. 6. Here, a multipole encoder 30 is provided as a wheel with changing magnetic poles. The rotation of this wheel brings about a change in the magnetic flux at the sensor element 31. The signals of the sensor element are evaluated by an ASIC, and then transmitted as digital signals to a controller ECU. These digital signals are denoted by the reference symbols 32.

Known principles are the Hall effect, the anisotropic magnetoresistive effect and the giant magnetoresistive (GMR) effect. The signal is conditioned by the ASIC (application-specific integrated circuit) and supplies a signal of movement-independent constant amplitude which is likewise transmitted continuously to the controller via cable by means of the network nodes and processed further there into a microcontroller. The other alternatives are described above.

FIG. 7 shows, in a block circuit diagram, a radio transmission between a vehicle sensor denoted by the reference symbols 40 to 45 and the controller ECU. The vehicle sensor has a single apparatus 40 for simultaneously generating the sensor signal and the energy. By means of an energy management system 41, which is usually arranged on an ASIC, the energy is stored in an energy store 41, for example a capacitor, which is also used for EMC (electromagnetic compatibility). The sensor signal is transmitted to an analog/digital converter within or outside the microcontroller 43 for digitization of the sensor signal. The microcontroller 43 stores the digitized sensor signals in a ring buffer 44 and transmits the data from the ring buffer 44 to a further transceiver 46 of the controller ECU via a transceiver 45 by means of radio signals if vehicle variables such as the vehicle speed and/or events such as locking of the wheels or slipping indicate this. This data can either be acquired from the sensor signal itself or from the controller ECU. For this purpose, the present radio traffic is also configured in a bidirectional fashion. The ASIC forms from the sensor signal a speed-dependent voltage signal which is already processed digitally in the sensor module. The microcontroller 43 can convert the sensor signal here into a controller-specific signal, and evaluate and store the data continuously in a toroidal memory. The stored data are generally, for example, then made available when there is an inadmissible change in speed and are passed on to the transceiver 42 in order to be transmitted to the controller ECU. The conversion in the ASIC or in the microcontroller into a digital speed signal or an acceleration signal permits easy further processing. This speed signal or acceleration signal can either be transmitted directly to the controller ECU with the transmitter 45 or with the transceiver at fixed discrete time intervals to the controller ECU, or the signal is further processed and evaluated in advance in the microcontroller. The speed-dependent or rule-based data transmission rate of the transceiver 45 which is described above can then be set here.

FIG. 8 illustrates an inventive detail of the vehicle sensor. A coil SP is connected to an ASIC both for sensor processing PP and for the generation of energy EE. The energy supply EE can, in particular, charge a capacitor C or else other capacitors or energy stores. The sensor signal which is conditioned by the sensor signal pre-processing means PP is transmitted to the transceiver TX, which irradiates the data via the antenna AT as a function of the sensor signal.

A possible embodiment of the transceiver TX is illustrated in FIG. 9. The digital signal can be firstly converted into an analog signal in order to amplify it and then modulate it, for example by means of sequence spreading or else frequency hopping. The modulation can also already take place in the digital form and an amplifier can also be used after the modulation. The receiver structure is configured in a converse fashion: downstream of a reception antenna there are usually a following frequency converter, an amplifier, a filter and digital signal processing means.

FIG. 10 shows in a flowchart a first embodiment of the method according to the invention. In the method step 100, the vehicle sensor WSS1 receives the data of the other sensors by radio. In the method step 101, pre-processing of this received data is optionally performed in the vehicle sensor WSS1. Furthermore, prioritization and pre-evaluation can also take place. Furthermore, the plausibility checking can be tested. Other method steps, which, for example, cause the controller ECU to be relieved, can also take place here. In the method step 102, the vehicle sensor WSS1 transmits the data to the ECU via the cable K1 according to priority, according to a rule in the multiplex. This data also includes the data which is measured by the vehicle sensor WSS1 itself. This data transmission can take place in data telegrams such as are described above. In the method step 103, the reception by the controller ECU takes place. The controller ECU also carries out fault correction of the received data. Other method steps can also take place here. In the method step 104, the determination of the vehicle state with the measured data is carried out.

FIG. 11 shows a further exemplary embodiment of the method according to the invention. In the method step 110, the vehicle sensor WSS1 as communication node in turn receives the data of the other sensors by radio. In the method step 111, the pre-processing described above takes place. In the method step 112, the testing by the vehicle sensor WSS1 now takes place to determine whether the cable transmission is suitable for the data transmission. This can be carried out, for example, by measurements of the resistance or of a test transmission to the controller ECU. In the method step 113 it is tested whether this test was successful or not. If it was successful, in the method step 114 the transmission to the controller ECU is then carried out via cable. In the method step 115, this data is received. However, if it was detected in the method step 113 that the transmission is not possible via cable, the system jumps to method step 117 which brings about the data transmission to the controller ECU by radio. After this, the system jumps in turn to method step 115 which describes the reception by the controller ECU. In the method step 116, the vehicle state is determined on the basis of the received data.

FIG. 12 shows a further exemplary embodiment of the method according to the invention. In the method step 120 it is detected that one of the communication nodes, for example the vehicle sensor WSS1, has failed. After this, the remaining vehicle sensors switch to a radio transmission to the controller ECU or to another driving communication node in the method step 121. In the method step 122, the determination of the vehicle state occurs again.

In FIG. 13, a last exemplary embodiment of the method according to the invention is described. In the method step 130, the communication nodes, for example the vehicle sensor WSS1, now receive their data via a specific addressing process. That is to say the radio signals have an address on the basis of which the communication node detects that the respective data are intended for it or not. In the method step 131, the transmission of data then takes place again from the communication node to the controller ECU. In the method step 133, the determination of the vehicle state takes place, wherein this is also carried out by the vehicle sensors using data addressed directly to the controller, this occurring in the method step 132.

1. A vehicle sensor comprising:
a radio interface for a radio-based data transmission; and
an interface for cable-bound data transmission.

2. The vehicle sensor as claimed in claim 1, wherein the radio interface is configured only for receiving the data.

3. The vehicle sensor as claimed in claim 1, further comprising:
a control which, when the cable-bound or the radio-based data transmission fails, switches over to the respective other type of transmission.

4. A system for use with a vehicle comprising:
a controller for vehicle state determination; and
at least two vehicle sensors,
wherein at least a first vehicle sensor is connected only by radio to the controller and/or to at least one second vehicle sensor for a first data transmission, and
wherein the at least one second vehicle sensor 1) is connected via cable to the controller for a second data transmission.

5. The system as claimed in claim 4, wherein:
the at least one second vehicle sensor transmits to the controller via a second data transmission the data which has been received via a third data transmission, and
said second vehicle sensor is therefore a first communication node.

6. The system as claimed in claim 5, wherein a first transmission rate for the second data transmission is higher than a second transmission rate for the first or the third data transmission.

7. The system as claimed in claim 4, wherein the at least one first vehicle sensor is also embodied as a second communication node.

8. The system as claimed in claim 5, wherein the first, the second, and the third data transmissions are of unidirectional design.

9. A method for operation of a vehicle system comprising:
determining a vehicle state with a controller;
connecting at least one first vehicle sensor only by radio to the controller and/or to at least one second vehicle sensor for a first data transmission; and
connecting the at least one second vehicle sensor via a cable to the controller for a second data transmission.

10. The method as claimed in claim 9, wherein the at least one second vehicle sensor transmits to the controller by means of the second data transmission the data which has been received by radio, and said at least one second vehicle sensor therefore acts as a communication node.
